(19) United States
(12) Patent Application Publication
(10) Pub. No.: US 2012/0044526 A1
(43) Pub. Date: Feb. 23, 2012

(54) PRINTING APPARATUS AND PROCESSING METHOD FOR THE SAME

(75) Inventors: Shinichi Miyazaki, Kawasaki-shi (JP); Yoshikazu Ishikawa, Yokohama-shi (JP); Toshiki Miyazaki, Tokyo (JP); Mitsuru Uratani, Kawasaki-shi (JP); Hiroshi Mori, Yokohama-shi (JP); Yumi Yanai, Kawasaki-shi (JP)

(73) Assignee: CANON KABUSHIKI KAISHA, Tokyo (JP)

(21) Appl. No.: 13/178,462

(22) Filed: Jul. 7, 2011

(30) Foreign Application Priority Data
Aug. 19, 2010 (JP) 2010-184330

(51) Int. Cl. G06F 15/00

(52) U.S. Cl. 358/1.15

(57) ABSTRACT

A printing apparatus encodes masks used for thinning out print data when performing multi-pass printing and provided in correspondence with passes, and stores the encoded masks in a memory. The printing apparatus includes an assignment unit that assigns different codes with respect to pixels that indicate dot-on and are held in the masks provided in correspondence with the passes, depending on for which pass of mask processing the masks are used, and an encoding unit that generates, using the different codes, index data indicating pixels that indicate dot-on and are held in the masks corresponding to the passes, and generates encoded data by encoding the index data. Here, the encoding unit determines an assignment relationship in which the different codes are assigned to the passes by the assignment unit such that the encoded data is smaller than the data size of original masks, and generates the encoded data.

### BACKGROUND OF THE INVENTION

1. Field of the Invention

The present invention relates to a printing apparatus and a processing method for the same.

2. Description of the Related Art

Printing apparatuses that have adopted an ink-jet system for printing using ink are known. Such printing apparatuses perform printing by causing a printhead to perform scanning relative to a printing medium, for example.

In general, such printing apparatuses have a function of performing multi-pass printing in order to improve print quality. In multi-pass printing, printing is performed by causing a printhead (carriage) to perform a plurality of scans in at least one of the forward and backward directions with respect to the same printing area.

When multi-pass printing is performed, generally, print data thinned out in correspondence with passes is generated by using masks. When performing multi-pass printing, the printing of each line is completed by a printhead performing a plurality of scans. Accordingly, in each line, pixels to be printed in each of a plurality of scans (passes) are in a complementary relationship with pixels to be printed in another pass. A mask is used in order to determine pixels to be printed in each of such a plurality of passes. For example, binary data corresponding to each pass is created by performing an AND operation on a 6×2 mask (data in which a pixel to be printed is represented by 1 and a pixel not to be printed is represented by 0) and print data (binary data).

The masks described above have various patterns. For example, Japanese Patent Laid-Open No. 07-052390 discloses technology utilizing random numbers for masks, and for example, Japanese Patent Laid-Open No. 06-143618 discloses masks for decreasing a ratio at which pixels adjacent to a boundary between pass areas are printed, in order to reduce joint streaks generated at the boundary.

Here, there are many cases where a printing apparatus holds masks therein in order to perform mask processing on print data (binary data). Such masks may be individually held in correspondence with a plurality of passes, which causes the data size thereof to be comparatively large. Accordingly, if a printing apparatus is constituted so as to hold masks therein, an increase in the capacity of memory (ROM and the like) will not be avoided, which would cause an increase in cost.

In order to eliminate this problem, Japanese Patent Laid-Open No. 08-183208 discloses technology for reducing the number of masks to be prepared so as to be one less than the number of print passes. In this technology, when data for one pass is generated by performing mask processing, new print data is generated by removing pixel data that is printed in the pass from print data that indicates an image to be printed. By repeating this processing for each pass, print data in which only pixel data to be printed in the last pass remains is generated for the last pass. Accordingly, mask processing will be unnecessary for the last pass, and thus the number of masks to be prepared can be reduced so as to be one less than the number of print passes.

With the technology of Japanese Patent Laid-Open No. 08-183208 described above, the number of masks to be prepared can be reduced so as to be one less than the number of print passes. Accordingly, for example, in a case of masks for two passes, the data size thereof can be reduced by half (a 50% decrease).

However, in a case of masks for 16 passes, the data size thereof is merely reduced so as to be 15/16 (a 6.25% decrease). Specifically, the more the number of passes is increased, the less the rate at which the data size of masks is reduced will be.

### SUMMARY OF THE INVENTION

The present invention provides technology for enabling the data size of masks to be reduced compared with a conventional configuration.

According to a first aspect of the present invention, there is provided a printing apparatus that encodes masks used for thinning out print data when performing multi-pass printing and provided in correspondence with passes, and stores the encoded masks in a memory, the apparatus comprising: an assignment unit configured to assign different codes with respect to pixels that indicate dot-on and are held in the masks provided in correspondence with the passes, depending on for which pass of mask processing the masks are used; and an encoding unit configured to generate, using the different codes, index data indicating pixels that indicate dot-on and are held in the masks corresponding to the passes, and generate encoded data by encoding the index data, wherein the encoding unit determines an assignment relationship in which the different codes are assigned to the passes by the assignment unit such that the encoded data is smaller than the data size of original masks, and generates the encoded data.

According to a second aspect of the present invention, there is provided a processing method for a printing apparatus that encodes masks used for thinning out print data when performing multi-pass printing and provided in correspondence with passes, and stores the encoded masks in a memory, the method comprising the step of: assigning different codes with respect to pixels that indicate dot-on and are held in the masks provided in correspondence with the passes, depending on for which pass of mask processing the masks are used; and generating, using the different codes, index data indicating pixels that indicate dot-on and are held in the masks corresponding to the passes, and generating encoded data by encoding the index data, wherein in the step of encoding, an assignment relationship in which the different codes are assigned to the passes in the step of assigning is determined such that the encoded data is smaller than the data size of original masks, and generates the encoded data.

Further features of the present invention will be apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a perspective view showing an example of an exterior configuration of a printing apparatus 10 according to an embodiment of the present invention.

FIG. 2 is a diagram showing an example of a control configuration of the printing apparatus 10 shown in FIG. 1.

FIG. 3 is a diagram showing a relationship between masks and print data.

FIG. 4 is a flowchart showing an example of a flow of mask encoding processing.

FIGS. 5A and 5B are diagrams illustrating the outline of mask encoding processing.

FIG. 6 is a diagram showing an example of a configuration of relation information.

FIG. 7 is a flowchart showing an example of a flow of mask decoding processing.

FIG. 8 is a diagram showing a relationship between masks and print data according to Embodiment 2.

FIGS. 9A and 9B are diagrams illustrating the outline of mask encoding processing according to Embodiment 2.

FIG. 10 is a diagram showing an example of a configuration of relation information according to Embodiment 2.

### DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

Note that the following description will exemplify a printing apparatus which adopts an ink-jet printing system. However, the present invention is not limited to such specific system. For example, an electrophotography system using toners as color materials may be adopted.

The printing apparatus may be, for example, a single-function printer having only a printing function, or a multifunction printer having a plurality of functions including a printing function, FAX function, and scanner function. Also, the printing apparatus may be, for example, a manufacturing apparatus used to manufacture a color filter, electronic device, optical device, micro-structure, and the like using a predetermined printing system.

In this specification, “printing” means not only forming significant information such as characters or graphics but also forming, for example, an image, design, pattern, or structure on a printing medium in a broad sense regardless of whether the formed information is significant, or processing the medium as well. In addition, the formed information need not always be visualized so as to be visually recognized by humans.

Also, a “printing medium” means not only a paper sheet for use in a general printing apparatus but also a member which can fix ink, such as cloth, plastic film, metallic plate, glass, ceramics, resin, lumber, or leather in a broad sense.

Also, “ink” should be interpreted in a broad sense as in the definition of “printing” mentioned above, and means a liquid which can be used to form, for example, an image, design, or pattern, process a printing medium, or perform ink processing upon being supplied onto the printing medium. The ink processing includes, for example, solidification or insolubilization of a coloring material in ink supplied onto a printing medium.

Also, a “nozzle” generically means an orifice, a liquid channel which communicates with it, and an element which generates energy used for ink discharge, unless otherwise specified.

### Embodiment 1

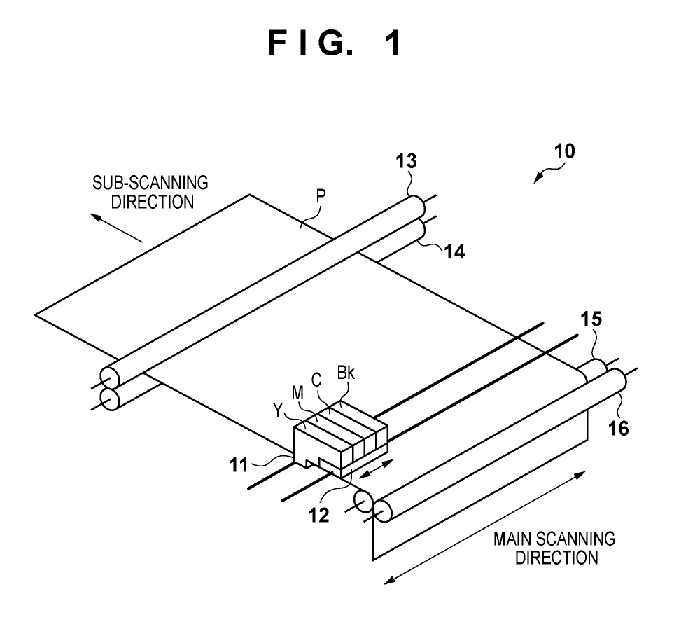

FIG. 1 is a perspective view showing an example of an exterior configuration of an ink-jet printing apparatus (hereinafter, referred to as printing apparatus) 10 according to an embodiment of the present invention.

In the printing apparatus 10, an ink-jet printhead (hereinafter, referred to as printhead) 11 that performs printing by ejecting ink in accordance with an ink-jet system is mounted on a carriage 12, and printing is performed by reciprocatively moving the carriage 12 in the main scanning direction.

The printing apparatus 10 feeds a printing medium P such as printing paper using a paper feed roller 15 and an assist roller 16, and conveys the printing medium P to a printing position. Then, the printing apparatus 10 performs printing by ejecting ink onto the printing medium P from the printhead 11 at the printing position. Upon the end of one printing scan by the printhead 11, a convey roller 13 and an assist roller 14 rotate, and the printing medium P is thereby conveyed in the sub-scanning direction by the amount corresponding to the printing width of the printhead 11. An image is printed on the printing medium P by repeating such a printing scan and a conveying operation.

The printhead 11 is provided with, for example, electrothermal transducers as printing elements. Specifically, the printhead 11 ejects ink utilizing thermal energy. The electrothermal transducers are provided in correspondence with orifices, and a pulse voltage is applied to a corresponding electrothermal transducer according to print data. Thus, ink is ejected from a corresponding orifice. Note that in the present embodiment, although a case where ink is ejected using a heater will be described as an ink ejection system, the present invention is not limited to this. For example, various ink-jet systems such as a system using a piezo-electric element, a system using an electrostatic element, and a system using a MEMS element may be adopted.

Other than the printhead 11, four ink cartridges that respectively contain yellow (Y), magenta (M), cyan (C), and black (Bk) ink are mounted on the carriage 12 of the printing apparatus 10. The ink cartridges store ink to be supplied to the orifices of the printhead 11. Each of the four ink cartridges can be independently detached and attached.

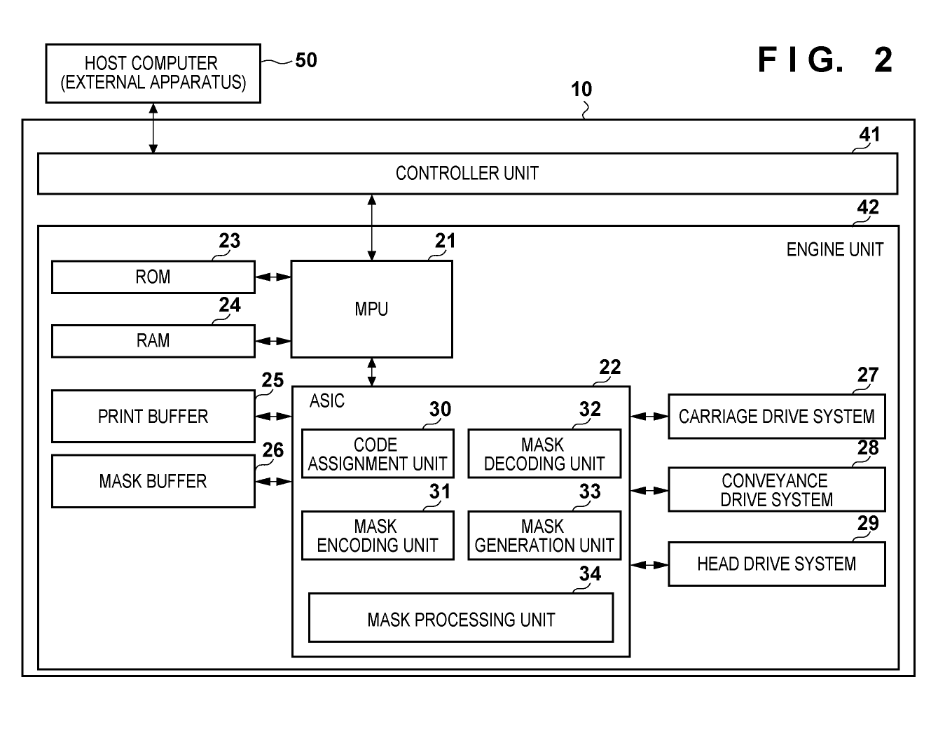

FIG. 2 is a diagram showing an example of a control configuration of the printing apparatus 10 shown in FIG. 1.

The printing apparatus 10 is connected to a host computer (which is an external apparatus, and may be simply referred to as “host” below) 50. The host 50 serves so as to supply image data to the printing apparatus 10. The host 50 is realized by a personal computer, a reader for image reading, or a digital camera, for example.

The printing apparatus 10 has a multi-pass printing mode in which the printhead 11 is caused to perform a plurality of scans with respect to the same printing area on a printing medium so as to complete printing of that area. Here, the configuration of the printing apparatus 10 is roughly divided into a controller unit 41 and an engine unit 42.

The controller unit 41 notifies the engine unit 42 of a control command in accordance with an instruction from an operation unit (not shown) of the printing apparatus 10 or the host 50. Further, when performing a printing operation, the controller unit 41 analyzes and develops image data received from the host 50, and converts the print data into binary print data of each color. Note that the operation unit is constituted by an input unit that inputs various instructions from a user, and a display unit that displays various pieces of information to the user.

The engine unit 42 performs a printing operation based on a control command and print data sent from the controller unit 41. The controller unit 41 and the engine unit 42 are connected to each other using a dedicated interface. For example, print data, control commands, and the like are sent from the controller unit 41 to the engine unit 42. Further, for example, status information for notifying a change of state of the controller unit 41 and the like are sent from the engine unit 42 to the controller unit 41.

Here, the engine unit 42 is constituted with an MPU 21, an ASIC 22, a ROM 23, a RAM 24, a print buffer 25, a mask buffer 26, a carriage drive system 27, a conveyance drive system 28, and a head drive system 29 being provided therein.

The MPU (Micro Processor Unit) 21 performs overall control of the operation of the units in the printing apparatus 10. The ROM (Read Only Memory) 23 stores therein various programs, and the RAM (Random Access Memory) 24 is used as, for instance, a work area when various processes are executed by the MPU 21. Note that the ROM 23 may be a memory in a rewritable format.

The MPU 21 also controls the carriage drive system 27, the conveyance drive system 28, and the head drive system 29 via the ASIC 22. Further, the MPU 21 is configured so as to be capable of performing reading from and writing to the print buffer 25 and the mask buffer 26 via the ASIC 22.

The print buffer 25 temporarily stores print data that has been converted into a format that allows the data to be transferred to the printhead (which may be referred to as nozzle data below).

The mask buffer 26 temporarily stores predetermined patterns (masks) for performing AND processing (mask based on logical multiplication) on data (print data) transferred from the print buffer 25 when the data is transferred to the printhead. The MPU 21 performs AND processing on a repetition of the masks and print data. Accordingly, data is thinned out according to passes when performing multi-pass printing.

In the ROM 23, a plurality of sets of masks is stored in an encoded state in order to handle multi-pass printing using different numbers of passes. When performing multi-pass printing, an encoded mask is read from the ROM 23 and decoded by the ASIC 22, and the decoded mask is stored in the mask buffer 26.

Here, the ASIC (processing device) 22 is internally provided with a code assignment unit 30, a mask encoding unit 31, a mask decoding unit 32, a mask generation unit 33, and a mask processing unit 34, as a functional configuration.

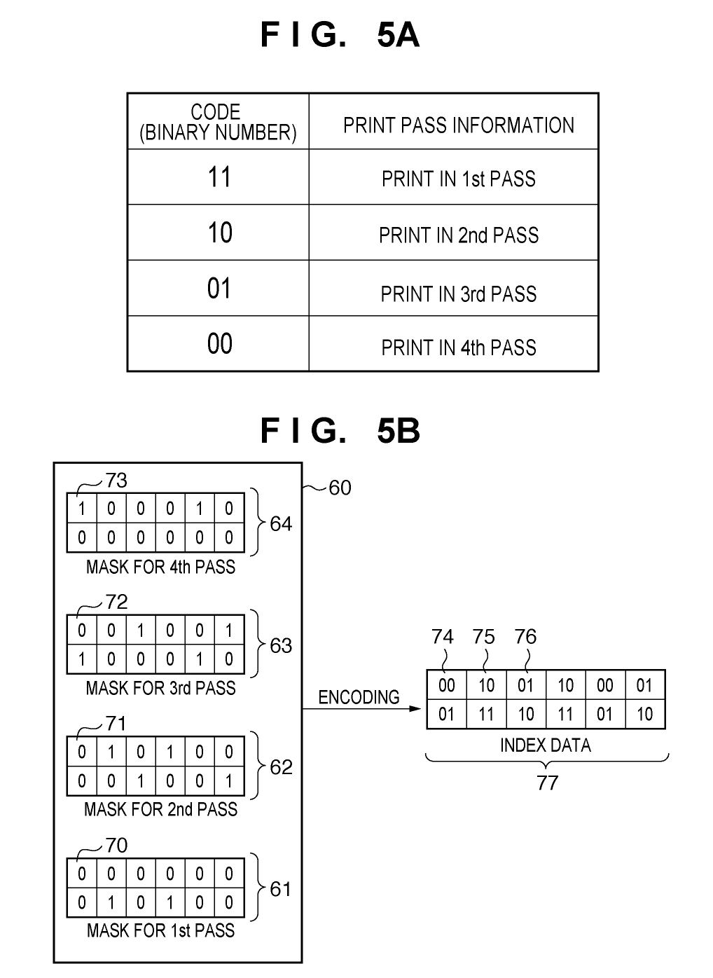

The code assignment unit 30 assigns codes with respect to pixels that indicate “dot-on” (pixels that allow printing in print data) and are held in masks provided in correspondence with passes. Although code assignment will be described in detail below, the value of a code to be assigned is determined depending on for which pass of mask processing a corresponding mask is used (see FIG. 5A described below).

The mask encoding unit 31 generates, using the codes, index data holding pixels that indicate “dot-on” and are held in a plurality of masks as one set of data, and encodes that index data. The encoded data obtained in this way is stored in the ROM 23, for example. Note that index data and the like will be described in detail below (see FIG. 5B described below).

The mask decoding unit 32 decodes encoded data stored in the ROM 23, and the like. The index data is obtained thereby. The mask generation unit 33 generates (restores) masks corresponding to passes based on the index data obtained by decoding.

The mask processing unit 34 performs AND processing on print data using the masks. Accordingly, when multi-pass printing is performed, data is thinned out according to the passes.

Here, in order to facilitate a description of the printing apparatus 10 according to the present embodiment, the flow of processing performed when multi-pass printing is performed will be briefly described.

The printing apparatus 10 starts a printing operation when image data is transmitted from the host 50. Specifically, first, the controller unit 41 in the printing apparatus 10 analyzes the received image data, and generates information necessary for printing such as print quality. Further, after analyzing the image data, the controller unit 41 develops that data to binary print data of each color. At this time, in the engine unit 42 of the printing apparatus 10, the mask decoding unit 32 reads encoded masks from the ROM 23, decodes the encoded masks, and thereafter stores the resultant masks in the mask buffer 26.

After that, the controller unit 41 in the printing apparatus 10 starts transferring the binary print data of each color to the engine unit 42. The engine unit 42 converts the transferred print data into nozzle data, and stores the nozzle data in the print buffer 25.

Here, when the amount of data held in the print buffer 25 reaches the amount that allows printing of actual band data, the MPU 21 controls the conveyance drive system 28 so as to convey a printing medium, and also controls the carriage drive system 27 so as to move the carriage 12. Further, the MPU 21 sets an image output position and the like with respect to the ASIC 22, and drives the carriage 12 so as to start printing.

When the carriage 12 moves and reaches a predetermined printing start position, the ASIC 22 sequentially reads nozzle data from the print buffer 25, and also reads corresponding masks from the mask buffer 26. Here, the ASIC 22 performs an AND operation (logical multiplication processing) on the nozzle data and the masks, and transfers print data obtained thereby to the printhead 11.

Thus, the printhead 11 drives a nozzle so as to eject ink in accordance with the transferred data based on the control of the head drive system 29. The printing apparatus 10 prints an image based on the image data transmitted from the host 50 on a printing medium by repeating the above processing.

Next is a description of mask encoding processing and mask decoding processing according to the present embodiment. Note that the multi-pass printing according to the present embodiment will be described using a case in which printing with respect to the same printing area is completed using four passes as an example.

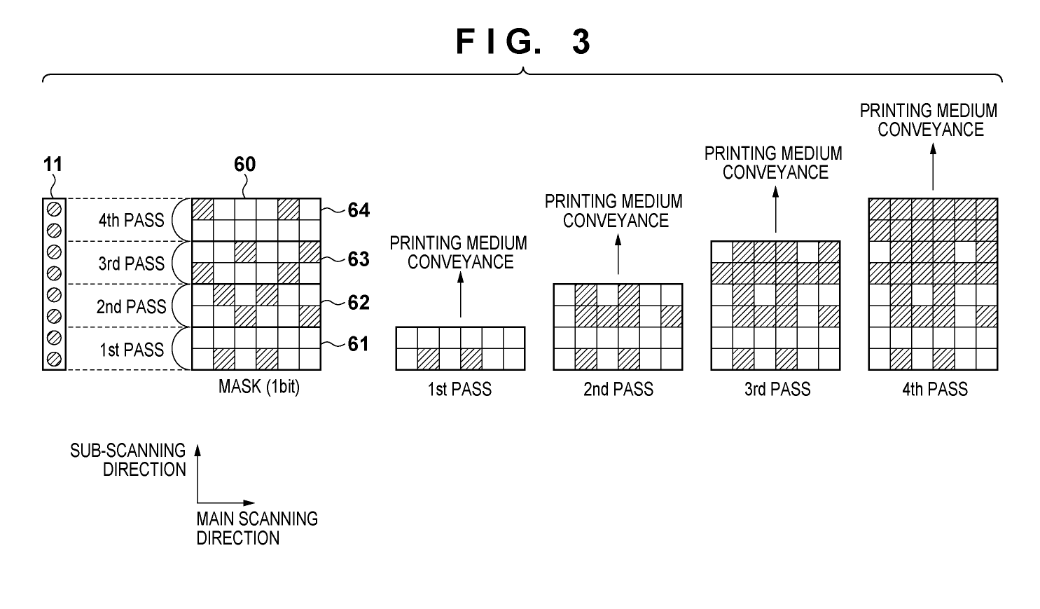

FIG. 3 is a diagram showing a relationship between masks for four passes and print data (nozzle data).

The masks are provided in correspondence with the passes. In the present embodiment, since multi-pass printing is performed using four passes, four masks (61 to 64) 60 for the first to fourth passes are used.

The masks are provided in correspondence with areas obtained by dividing a nozzle row of the printhead 11 into four groups, since multi-pass printing is performed using four passes. Here, an area for one pass includes two pixels in the sub-scanning direction and six pixels in the main scanning direction, to facilitate the description. Accordingly, the four masks 60, as a whole, include eight pixels in the sub-scanning direction and six pixels in the main scanning direction. In the present embodiment, the masks for the passes are configured such that all the pixels in one pass area become “dot-on” if an OR operation (logical addition processing) is performed on the four masks (61 to 64) pixel-by-pixel at the same position.

FIG. 3 shows a case in which a printing medium is conveyed by one pass (two nozzles) worth of distance at a time in the sub-scanning direction (the upward direction of the diagram), with respect to the nozzle row of the printhead 11. Data to be printed in the passes is obtained by performing an AND operation (logical multiplication processing) on the masks and the print data. For this reason, the positions of dots that are printed in a pass are equal to those as a result of an OR operation (logical addition processing) being performed on the masks up to that pass, and thus the output result of the dots after the end of printing for four passes is image data itself (in other words, printing of an image is completed).

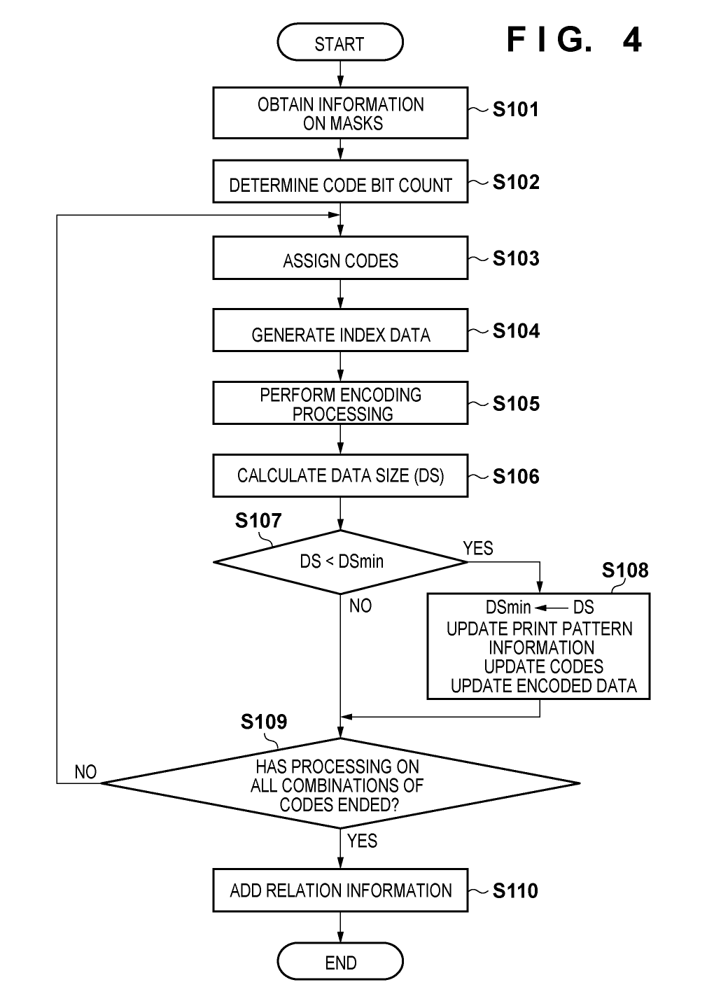

Here, an example of the flow of processing performed when masks are encoded in the printing apparatus 10 shown in FIG. 1 will be described with reference to FIG. 4. The description here will be given using a case where the masks 60 shown in FIG. 3 are encoded as an example.

Upon the start of this processing, first, the code assignment unit 30 in the printing apparatus 10 obtains information on masks (S101). Examples of information on masks include the number of passes and the number of masks for when multi-pass printing is performed, and the like.

Upon the end of obtaining of information on masks, the code assignment unit 30 in the printing apparatus 10 creates print pattern information shown in FIG. 5A. In the creation of print pattern information, first, the number of bits used for expressing codes is determined (S102). In the present embodiment, four masks are used since multi-pass printing using four passes is performed. Accordingly, since it is sufficient that codes can represent four information pieces, the bit count thereof is determined as being 2 (00, 01, 10, 11 (binary numbers)), for example.

Subsequently, the code assignment unit 30 in the printing apparatus 10 associates codes with print pass information (S103). In this case, “11 (binary number)” is assigned to “print in the first pass”, “10 (binary number)” is assigned to “print in the second pass”, “01 (binary number)” is assigned to “print in the third pass”, and “00 (binary number)” is assigned to “print in the fourth pass”. In this way, print pattern information is created. Codes and print pass information are specified in the print pattern information in association with each other. Information specified in this print pattern information is used to indicate in which pass pixels are to be printed.

Upon the end of the creation of print pattern information, the mask encoding unit 31 in the printing apparatus 10 generates index data (S104). FIG. 5B shows the four masks 60 and index data 77 generated from the four masks 60. In the index data 77, pixels that indicate “dot-on” and are held in the four masks 60 are specified using the codes.

The masks (61 to 64) represent the masks shown in FIG. 3 as binary data, and a pixel at which a dot is formed is shown by “1”, whereas a pixel at which a dot is not formed is shown by “0”. A pixel 70 of the mask 61 for the first pass, a pixel 71 of the mask 62 for the second pass, a pixel 72 of the mask 63 for the third pass, and a pixel 73 of the mask 64 for the fourth pass all indicate the same pixel. A pixel 74 of the index data 77 corresponds to the pixels 70 to 73 of the masks for the first to fourth passes. In this case, only the pixel 73 of the mask 64 for the fourth pass indicates “1” among the pixels (70 to 73) at the upper left in the masks, and thus when the pixel value of print data corresponding to that pixel is 1 (dot-on), that dot is printed in the fourth pass.

Note that in the pixel 74 of the index data 77, the code “00 (binary number)” assigned to “print in the fourth pass” in the processing in S103 is set. Similarly, the code “10 (binary number)” indicating “print in the second pass” is set in a pixel 75, and the code “01 (binary number)” indicating “print in the third pass” is set in a pixel 76.

Here, the mask encoding unit 31 in the printing apparatus 10 performs encoding processing on the index data 77 (S105). For this encoding, it is sufficient to use, for example, the JBIG encoding system, which is lossless encoding. The JBIG encoding system is an encoding technique with a function of learning a two-dimensional feature of bitmap data to be compressed. In the present embodiment, assuming that the index data 77 is binary bit map data, the JBIG encoding system is applied thereto, and encoded data is generated.

Next, the mask encoding unit 31 in the printing apparatus 10 calculates the data size (DS) of the encoded data generated by performing the processing in S105 (S106), and compares the calculated data size (DS) with the smallest data size (DSmin) (S107). For the initial value of the smallest data size (DSmin), it is sufficient to use the data size of the index data 77 generated (first) by performing processing in S104.

As a result of comparison, if the data size (DS) is greater than or equal to the smallest data size (NO in S107), the mask encoding unit 31 in the printing apparatus 10 determines whether or not processing on all the combinations of the codes has ended. Further, if the data size (DS) is smaller than the smallest data size (DSmin) (YES in S107), the mask encoding unit 31 in the printing apparatus 10 updates the smallest data size (DSmin) with the data size (DS). Further, the mask encoding unit 31 updates the codes assigned in the processing in S103, print pass information associated therewith, and the encoded data generated by performing the processing in S105 (S108).

Note that the initial values of the codes and print pass information are the codes assigned (first) by performing the processing in S103, and the print pass information associated therewith. The initial value of encoded data is the index data 77 generated by performing the processing in S104 from the codes assigned (first).

After that, the mask encoding unit 31 in the printing apparatus 10 determines whether or not processing on all the combinations of the codes and print pass information has ended. Specifically, encoded data is generated for all the combinations by changing the assignment relationship shown in FIG. 5A in which the codes are assigned to print pass information, and a determination regarding the data sizes thereof is made (S103 to S108).

As a result of determination, if the processing described above has not been implemented on all the combinations (NO in S109), the processing returns to processing in S103, where the code assignment relationship is changed, and thereafter the processing described above is performed again.

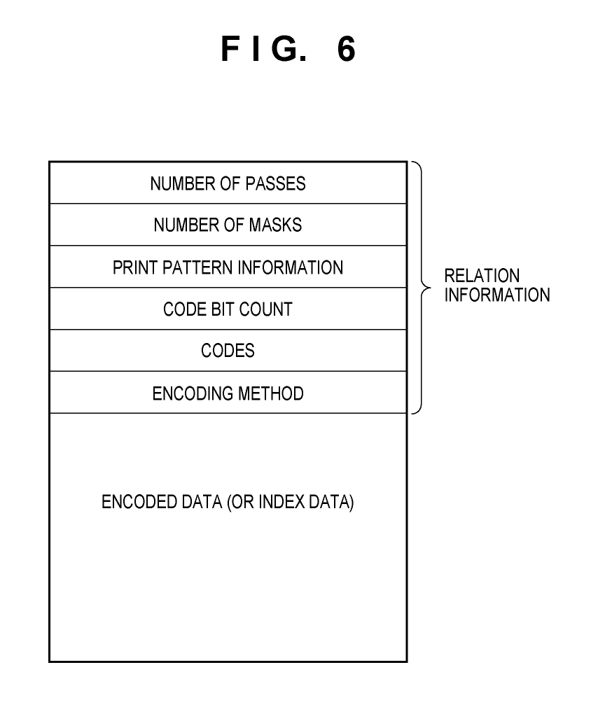

If the processing described above has been implemented on all the combinations (YES in S109), relation information (header information) necessary when decoding the encoded data updated in the processing in S108 is added to that data (S110), and thereafter this processing ends. Note that relation information includes the number of passes, the number of masks, print pattern information, code bit count, codes, and information on the encoding method, as shown in FIG. 6. In the case of the above description, the number of passes and the number of masks are “4”, and the code bit count is “2”. Further, in the information on the encoding method, 1-bit information indicating “JBIG encoding processing not performed (0)” or “JBIG encoding processing performed (1)” is held. If the smallest data size (DSmin) still indicates the initial value, “JBIG encoding processing not performed (0)” is set, and if the smallest data size does not indicate the initial value, “JBIG encoding processing performed (1)” is set. Note that information on the encoding method indicates “JBIG encoding processing not performed (0)”, the encoded data shown in FIG. 6 is not data that has been encoded, but rather is index data generated by performing the processing in S104 from the codes assigned first.

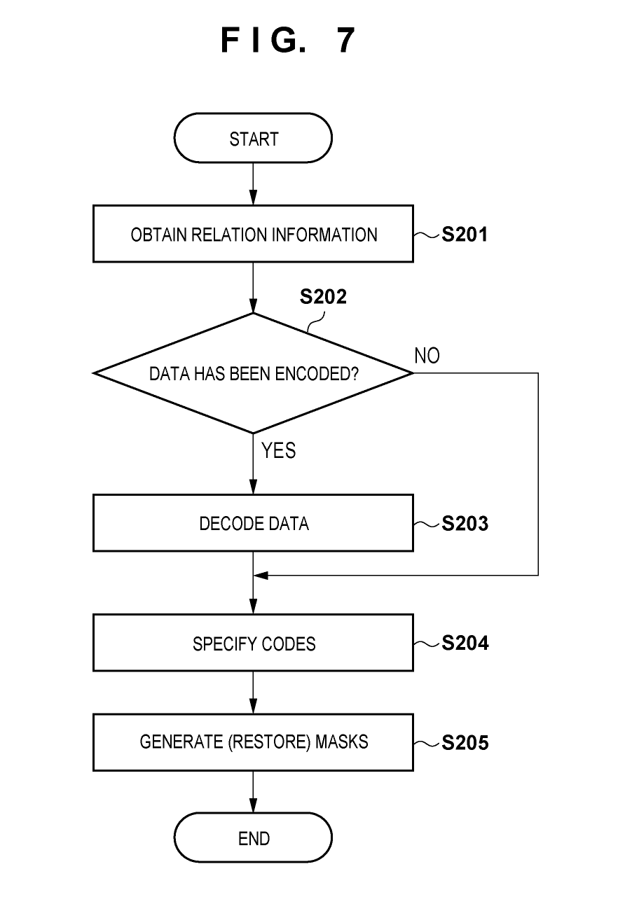

Next is a description of an example of the flow of processing performed when masks are decoded in the printing apparatus 10 shown in FIG. 1, with reference to FIG. 7. The description here is given using a case where the masks shown in FIG. 5B are decoded as an example.

Upon the start of this processing, first, the mask decoding unit 32 in the printing apparatus 10 obtains relation information (S201). Specifically, the relation information shown in FIG. 6 is obtained. Then, it is determined whether or not index data has been encoded by referencing the information on the encoding method included in the relation information.

As a result of determination, if the index data is not encoded (NO in S202), the mask decoding unit 32 does not perform decoding processing, and obtains index data as it is. On the other hand, if the index data has been encoded (YES in S202), the mask decoding unit 32 implements decoding processing on the encoded data (S203).

After that, the mask generation unit 33 in the printing apparatus 10 specifies codes assigned in association with print pass information, based on code bit count, the number of masks, print pattern information, and information on codes included in the relation information (S204).

Subsequently, the mask generation unit 33 in the printing apparatus 10 generates (restores) masks from the index data based on the number of passes, code bit count, print pattern information, and the codes specified by performing the processing in S204 (S205). After that, this processing ends.

Here, mask generation processing shown in S205 will be described with reference to FIG. 5B described above.

Since the code bit count can be specified as being 2 by performing the processing in S201, the pixel 74 (2 bits) can be specified from the index data 77. The code of the pixel 74 is “00 (binary number)”, and it has also been specified that “00” is assigned to “print in the fourth pass”, and thus the mask decoding unit 32 sets “1” in the pixel 73 of the mask 64 for the fourth pass.

The mask decoding unit 32 sets “0” in the pixels 70 to 72 of the mask 61 for the first pass to the mask 63 for the third pass. The masks corresponding to the passes can be generated by also performing processing with respect to the remaining pixels (such as 75 and 76) of the index data 77 following the same procedure.

As described above, according to the present embodiment, the size of data after encoding (encoded data) is determined, and it is determined whether or not to adopt that encoded data. Accordingly, the size of the encoded data finally stored in the ROM 23 will not be larger than index data.

Further, data size determination is performed with respect to all the combinations of the codes and print pass information, and thus codes can be assigned such that the compression rate at the time of encoding is maximized. Accordingly, the memory capacity necessary for storing masks can be greatly reduced.

### Embodiment 2

Next is a description of Embodiment 2. Here, in Embodiment 2, the configuration of masks differs from that in Embodiment 1. Specifically, the masks according to Embodiment 2 include pixels at which a dot is formed a plurality of times in different passes when multi-pass (four passes) printing is performed.

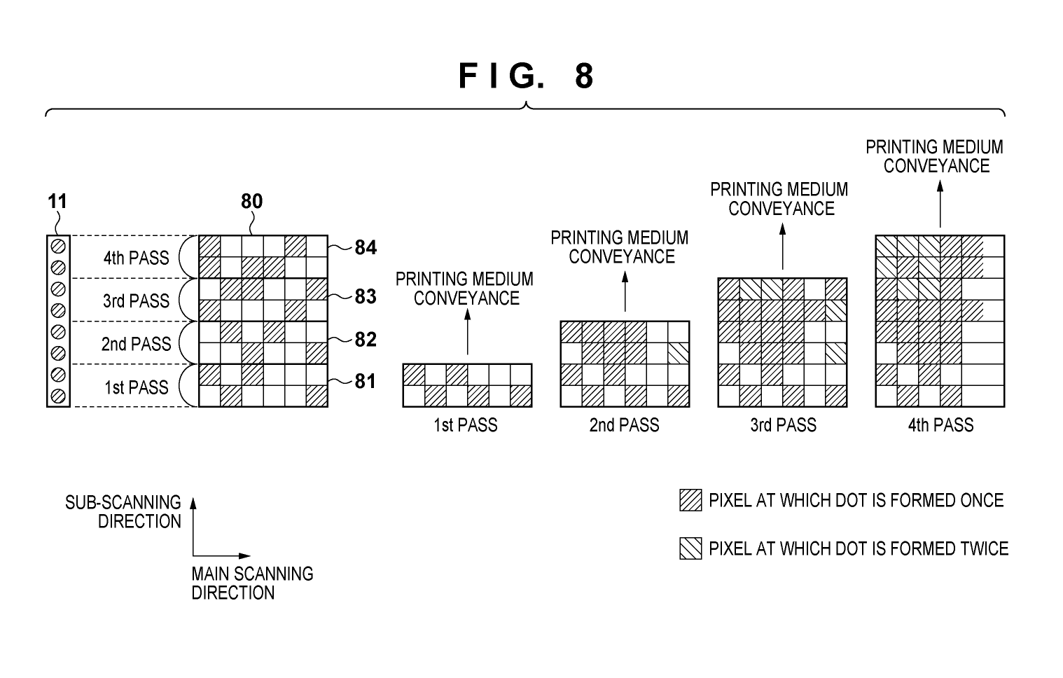

The masks according to Embodiment 2 will be described with reference to FIG. 8. Here, a difference from FIG. 3 illustrating Embodiment 1 is that pixels at which a dot is formed twice in different passes when performing multi-pass printing (four passes) are included. Specifically, the masks shown in FIG. 8 include pixels printed in the first and second passes, pixels printed in the second and third passes, and the like.

If an OR operation (logical addition processing) is performed pixel-by-pixel on pixels at the same position of four masks (81 to 84), all the pixels in one pass area become “dot-on”. Furthermore, the masks for the passes are configured such that a dot is formed twice at 6 pixels among the pixels.

Here, an example of the flow of processing performed when masks are encoded in the printing apparatus 10 according to Embodiment 2 will be described. Note that the flow of overall processing of mask encoding processing is the same as that in Embodiment 1, and thus here, the differences from Embodiment 1 will be mainly described with reference to FIG. 4.

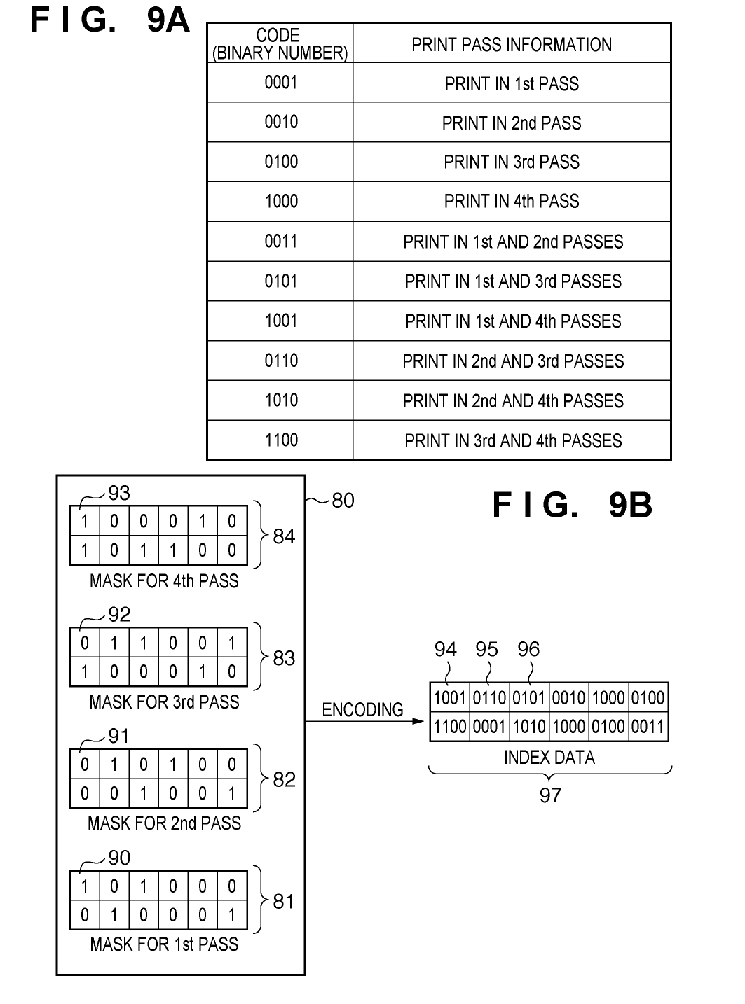

In Embodiment 2, the bits of codes indicate dot ON/OFF information in the passes as shown in FIG. 9A. Accordingly, in the processing in S102, the code bit count is determined as being “4” in accordance with the number of passes.

Association shown in FIG. 9A is performed in the processing in S103. In this case, “0001 (binary number)” is assigned to “print in the first pass”, “0010 (binary number)” is assigned to “print in the second pass”, “0100 (binary number)” is assigned to “print in the third pass”, and “1000 (binary number)” is assigned to “print in the fourth pass”. Further, a code such as “0011” is assigned to “print in the first and second passes”. Specifically, if a least significant bit (bit on the rightmost side) is ON, this indicates that the pixel is to be printed in the first pass. If a bit in one level higher than the least significant bit (a bit at the second position from the right) is ON, this indicates that the pixel is to be printed in the second pass. Thus, in Embodiment 2, the codes are assigned in association with the print patterns such that the bits of the codes indicate dot ON/OFF information in the passes.

Further, in the generation of index data in the processing in S104, index data 97 shown in FIG. 9B is generated. Here, four masks 80 shown in FIG. 9B are shown as binary data in which a pixel at which a dot is formed is shown by “1”, whereas a pixel at which a dot is not formed is shown by “0”. In this case, among pixels (90 to 93) at the upper left in the masks, the pixel 90 of the mask 81 for the first pass and the pixel 93 of the mask 84 for the fourth pass indicate “1”. Accordingly, if the pixel value of print data corresponding to these pixels is 1 (dot-on), the dot is printed in the first and fourth passes. In the position corresponding to these pixels (90 and 93) of the index data 97, the code “1001 (binary number)” is set. Note that the subsequent processing (S105 and subsequent steps) follows the same flow as the processing in Embodiment 1, and thus a description thereof is omitted here.

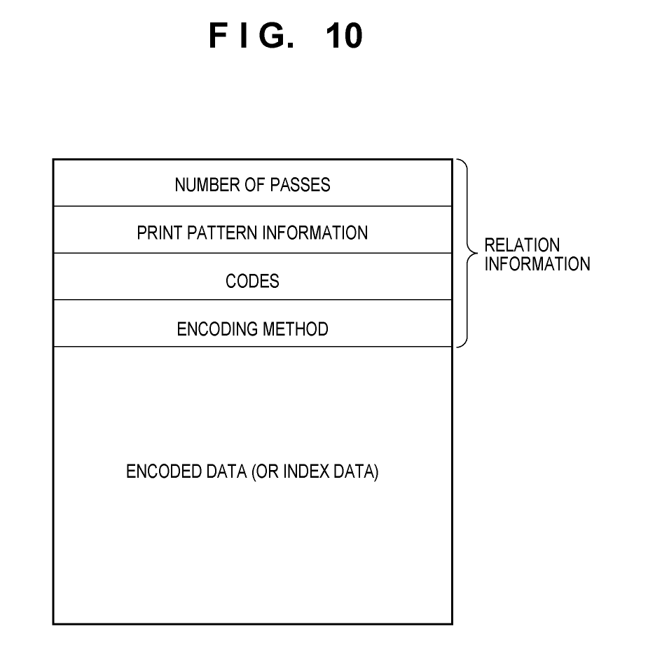

FIG. 10 is a diagram showing an example of a configuration of relation information according to Embodiment 2.

In Embodiment 2, the number of passes, print pattern information, codes, and information on the encoding method is added to encoded data (or index data) as relation information. Information on the code bit count and the number of masks is omitted from the relation information shown in FIG. 6 illustrating Embodiment 1. The reason why the code bit count is omitted is that the code bit count can be specified in the case of Embodiment 2 if the number of passes is known. For example, in the case of multi-pass printing using five passes, the bit count is “5”. Further, information on the number of masks is also omitted for the same reason.

Next is a description of an example of the flow of processing performed when masks are decoded in the printing apparatus 10 according to Embodiment 2. Note that the overall flow of the processing of mask decoding processing is the same as that of Embodiment 1, and thus here, processing performed when generating (restoring) masks is described with reference to FIG. 9B, mainly focusing on the differences from Embodiment 1.

Here, with regard to the number of passes, the code bit count can be specified as being “4” based on the number of passes “4” included in the relation information obtained by performing the processing in S201. Accordingly, the pixel 94 (4 bits) can be specified from the index data 97 shown in FIG. 9B. It is also possible to specify that the code of the pixel 94 is “1001 (binary number)”, and “1001” is assigned to “print in the first and fourth passes” from the print pattern information.

Thus, the mask decoding unit 32 sets “1” in the pixel 90 of the mask 81 for the first pass and in the pixel 93 of the mask 84 for the fourth pass, and sets “0” in the pixel 91 of the mask 82 for the second pass and in the pixel 92 of the mask 83 for the third pass. The masks corresponding to the passes can be generated by also performing processing on the remaining pixels (such as 95 and 96) of the index data 97 following the same procedure.

As described above, according to Embodiment 2, codes are assigned in association with print patterns such that the bits of the codes indicate dot ON/OFF information in the passes, and index data is thereby generated.

Accordingly, even in the case of masks configured such that the same pixel is printed a plurality of times when performing multi-pass printing, such masks can be encoded and decoded as in Embodiment 1.

Although the above are examples of representative embodiments of the present invention, the present invention is not limited to the embodiments described above and shown in the drawings, and can be modified as appropriate without departing from the gist of the invention, and implemented.

For example, the configuration of masks described above is merely an example, and both the size and data are not limited to the shown configurations. Further, although the number of multi-passes has been described using a case where the number thereof is “4” as an example, the present invention is not limited to this, and multi-pass printing may be performed using any number of passes.

Although the above description has been given using a case where the code bit count is 2 or 4, the bit count is not limited to this, either. Specifically, it is sufficient that codes can be assigned such that the data size of encoded data is smaller than the data size of original masks.

It is sufficient that codes can be assigned such that the data size of encoded data is smaller than the data size of original masks. Accordingly, processing in S103 to S108 in FIG. 4 does not need to be repeatedly implemented for all the combinations of the code assignment relationship. Further, a configuration may be adopted in which in the comparison shown in S107 in FIG. 4, the data size of original masks (four masks in the case of the embodiments) is compared with the size of encoded data.

Although the code assignment relationship is determined based on the comparison (S107 in FIG. 4) of the data size of encoded data in the above description, the present invention is not limited to this. Any technique may be used as long as codes can be determined such that the data size of encoded data is smaller than the data size of original masks.

Information on masks described above (such as the number of passes and the number of print patterns) and information on codes may be configured to be obtained every time processing is performed, or may be values determined as fixed values. It goes without saying that in accordance therewith, corresponding processing in the encoding processing and decoding processing described above, the configuration of relation information, and the like can be changed as appropriate.

Although the above was a description using a case where encoding processing is performed using the JBIG encoding system as an example, any system may be used as long as the system is a lossless encoding system. Further, a configuration may be adopted in which a combination of a code and an encoding system is changed using a system selected from among a plurality of encoding systems, such that the data size of encoded data is smaller than the data size of original masks.

The encoding processing in the embodiments described above is not necessarily a required configuration. For example, a configuration may be adopted in which encoded mask data is stored in advance in the ROM 23 of the printing apparatus. Further, it is also possible to provide the printing apparatus with a function of adding a mask, and in this case, the printing apparatus is caused to execute processing for adding encoded data obtained by performing the processing in FIG. 4 or processing for changing a mask using encoded data obtained by performing the processing in FIG. 4. Although a mask that is added or changed may be supplied from the host 50, alternatively, for example, a memory card may be mounted to a memory card unit (not shown) of the printing apparatus, and the printing apparatus may supply a mask by reading the mask from the memory card. Furthermore, when obtaining mask data, the host 50 may obtain mask data by a memory card being mounted thereto or may download mask data via a network.

Further, although the above was a description using an ink-jet printing apparatus that performs a printing operation using a printhead as an example, the present invention is not limited to this. Any apparatus may be used as long as the apparatus forms an image in a predetermined region of a printing medium by performing a printing operation a plurality of times.

As described above, according to the present invention, it is possible to reduce the data size of masks compared with a conventional configuration.

Note that the present invention can also be embodied as, for example, a system, an apparatus, a method, a program, a recording medium, or the like. Specifically, the present invention may be applied to a system constituted by a plurality of devices, and may also be applied to an apparatus constituted by one device.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-184330 filed on Aug. 19, 2010, which is hereby incorporated by reference herein in its entirety.

What is claimed is:

1. A printing apparatus that encodes masks used for thinning out print data when performing multi-pass printing and provided in correspondence with passes, and stores the encoded masks in a memory, the apparatus comprising:
an assignment unit configured to assign different codes with respect to pixels that indicate dot-on and are held in the masks provided in correspondence with the passes, depending on for which pass of mask processing the masks are used; and
an encoding unit configured to generate, using the different codes, index data indicating pixels that indicate dot-on and are held in the masks corresponding to the passes, and generate encoded data by encoding the index data,
wherein the encoding unit determines an assignment relationship in which the different codes are assigned to the passes by the assignment unit such that the encoded data is smaller than the data size of original masks, and generates the encoded data.

2. The printing apparatus according to claim 1,
wherein the encoding unit generates the encoded data for all combinations of the different codes and the passes that are obtained by changing the assignment relationship in which the different codes are assigned to the passes, and stores encoded data having the smallest size among the generated encoded data in the memory.

3. The printing apparatus according to claim 1,
wherein the encoding unit generates the encoded data for combinations of the different codes and the passes that are obtained by changing the assignment relationship in which the different codes are assigned to the passes, and stores the index data in the memory if encoded data having the smallest size among the generated encoded data is larger than the size of the index data.

4. The printing apparatus according to claim 1,
wherein the encoding unit adds, to the encoded data, relation information necessary when the encoded data is decoded, and stores the encoded data in the memory.

5. The printing apparatus according to claim 4, further comprising:
a decoding unit configured to decode the encoded data stored in the memory, and obtain the index data;
a mask generation unit configured to generate masks corresponding to the passes from the obtained index data based on the relation information; and
a mask processing unit configured to perform mask processing using the print data and the masks corresponding to the passes, and generate print data thinned out in correspondence with the passes.

6. The printing apparatus according to claim 4,
wherein the relation information includes the number of passes for when the multi-pass printing is performed, the number of masks used when the multi-pass printing is performed, information indicating the assignment relationship of the codes, the codes, code bit count, and an encoding method.

7. A processing method for a printing apparatus that encodes masks used for thinning out print data when performing multi-pass printing and provided in correspondence with passes, and stores the encoded masks in a memory, the method comprising the step of:
assigning different codes with respect to pixels that indicate dot-on and are held in the masks provided in correspondence with the passes, depending on for which pass of mask processing the masks are used; and
generating, using the different codes, index data indicating pixels that indicate dot-on and are held in the masks corresponding to the passes, and generating encoded data by encoding the index data,
wherein in the step of encoding, an assignment relationship in which the different codes are assigned to the passes in the step of assigning is determined such that the encoded data is smaller than the data size of original masks, and generates the encoded data.
